(19) United States
(12) Patent Application Publication
(10) Pub. No.: US 2025/0385360 A1
(43) Pub. Date: Dec. 18, 2025

(54) PRISMATIC BATTERY CELL INCLUDING MULTILAYER ELECTRODE STACKS IN A VERTICALLY STACKED CONFIGURATION

(71) Applicant: GM GLOBAL TECHNOLOGY OPERATIONS LLC, Detroit, MI (US)

(72) Inventors: Liang Xi, Northville, MI (US); Binsong Li, Troy, MI (US); Fengkun Wang, Rochester Hills, MI (US); SriLakshmi Katar, Troy, MI (US); Ryan P. Hickey, Austin, TX (US); Taylor R. Garrick, Bloomfield Hills, MI (US)

(73) Assignee: GM GLOBAL TECHNOLOGY OPERATIONS LLC, Detroit, MI (US)

(21) Appl. No.: 18/743,336

(22) Filed: Jun. 14, 2024

(51) Int. Cl. H01M 50/211; H01M 50/249; H01M 50/463; H01M 50/566

(52) U.S. Cl. CPC H01M 50/211; H01M 50/249; H01M 50/463; H01M 50/566

(57) ABSTRACT

A prismatic battery cell includes a battery can defining an internal volume. The battery can includes a first side, a second side opposite the first side, a bottom portion, a top cover portion opposite the bottom portion, and at least two electrode stacks. The top cover portion includes an anode terminal, and a cathode terminal. Each of the anode terminal and the cathode terminal extend through the top cover portion of the battery can. Each of the at least two electrode stacks include a first electrode stack, and a second electrode stack, which are both disposed within the internal volume defined by the battery can in a vertically stacked arrangement. A thermal barrier plate may be disposed between the first and second electrode stacks.

### INTRODUCTION

The concepts described herein relate generally to vehicles employing electrified powertrain or propulsion systems, which are composed of a rechargeable energy storage system (RESS) that includes battery packs each including a plurality of individual direct current (DC) battery cells providing electric power to control operation of one or multiple electric machines.

A prismatic battery cell is a DC battery cell that generally includes a single electrode “stack,” disposed within a metal can, which is generally rectangular in shape. The electrode stack, or current collector, is made up of layers of positive electrodes (cathodes), negative electrodes (anodes) and separator layers disposed between the anode and the cathode. sandwiched together. The electrode stack may also be rolled into a modified jelly roll prior to being disposed within the metal can.

Each anode within the electrode stack includes an anode tab, and each cathode within the electrode stack includes a cathode tab, each of the anode tab and the cathode tab being disposed on their respective top edges of the anode and the cathode. Each anode tab generally extends upwardly from a body of each anode and each cathode tab generally extends upwardly from a body of each cathode.

Some battery packs may require tall prismatic battery cells having a relatively long cell height and a relatively small cell width. The width of the prismatic battery cell may not be wide enough to accommodate both the anode tab and the cathode tab on the top edge of the electrodes, while the height the prismatic battery cell may require that the electrode stack, or current collector, be similarly long, which may result in higher cell resistance and lower cell performance.

Tall prismatic battery cells typically include a single electrode stack that has a long cell height, resulting in decreased manufacturability due to long insertion depth during the electrode stacking process, or, in some cases, a lack of manufacturability due to a maximum electrode insertion limit of an electrode stacking machine.

### SUMMARY

In view of the above discussion, it is useful to develop a prismatic battery cell having multiple separate electrode stacks stacked in a vertical configuration within a single metal can, which lowers cell resistance, and improves battery performance and electrode stack manufacturability.

The concepts disclosed herein relate to a prismatic battery cell including at least two separate electrode stacks within a single metal can. Each of the electrodes within each of the electrode stacks includes a tab that extend outwardly from a side of each electrode, and each electrode stack has a length that is shorter than the length of the battery cell, such that a combined length of the electrode stacks is similar to the length of the battery cell.

A prismatic battery cell may include a battery can defining an internal volume. The battery can may include a first side, a second side opposite the first side, a bottom portion, a top cover portion opposite the bottom portion, and at least two electrode stacks,

The electrode stacks may include including a first electrode stack, and a second electrode stack disposed within the internal volume defined by the battery can in a vertically stacked arrangement.

A bottom edge of the first electrode stack may be adjacent to the bottom portion of the battery can, a bottom edge of the second electrode stack may be adjacent to a top edge of the first electrode stack, and a top edge of the second electrode stack may be adjacent to the top cover portion of the battery can.

Each of the first electrode stack and the second electrode stack may include at least two pairs of electrodes. Each pair of electrodes may include an anode, a cathode adjacent to the anode in a stacked configuration, and a separator layer disposed between the anode and the cathode.

Each anode may include an anode current collector portion and an anode tab portion extending outward from the anode current collector portion toward the first side of the battery can.

Each cathode may include a cathode current collector portion and a cathode tab portion extending outward from the cathode current collector portion toward the second side of the battery can.

The prismatic battery cell may include an anode terminal, a cathode terminal, a first internal weld plate, and a second internal weld plate.

The anode terminal may extend through at least one of the first side, the second side, the bottom portion, and the top cover portion of the battery can. The cathode terminal may extend through at least one of the first side, the second side, the bottom portion and top cover portion of the battery can.

The first internal weld plate may be connected to the anode tab portions of the first electrode stack, the anode tab portions of the second electrode stack, and the anode terminal. The second internal weld plate may be connected to the cathode tab portion of the first electrode stack, the cathode tab portion of the second electrode stack, and the cathode terminal.

Each the first internal weld plate and the second internal weld plate may be in thermal communication with the battery can.

The first electrode stack may include a first plurality of pairs of electrodes, and the second electrode stack may include a second plurality of pairs of electrodes. Each of the first plurality of pairs of electrodes and the second plurality of pairs of electrodes may be disposed in a stacked configuration.

The separator layer of the first electrode stack may be disposed between each anode and cathode included in each of the first plurality of pairs of electrodes, and between each of the first plurality of pairs of electrodes.

The separator layer of the second electrode stack may be disposed between each anode and cathode included in each of the second plurality of pairs of electrodes, and between each of the second plurality of pairs of electrodes.

The separator layer of the first electrode stack may include a z-stack configuration, and the separator layer of the second electrode stack may also include a z-stack configuration.

According to one aspect of the disclosure, the prismatic battery cell may include an insulation plate disposed within the internal volume defined by the battery can. The insulation plate may be disposed adjacent to the top cover portion of the battery can.

According to one aspect of the disclosure, the prismatic battery cell may include a thermal barrier plate disposed between the first electrode stack and the second electrode stack.

According to one aspect of the disclosure, each of the first electrode stack and the second electrode stack may include a jelly-roll configuration.

According to one aspect of the disclosure, the prismatic battery cell may include at least one thermally conductive layer disposed within the internal volume defined by the battery can. The at least one thermally conductive layer may be disposed adjacent to the first side and/or the second side of the battery can.

A rechargeable energy system (RESS) for an electrified vehicle is also disclosed herein. The RESS may include a plurality of prismatic battery cells in accordance with the description above.

An electrified vehicle including a RESS, which may include a plurality of prismatic battery cells in accordance with the description above is also disclosed herein.

A prismatic battery cell including multiple multilayer electrode stacks stacked within the battery can in a vertically stacked configuration allows for smaller electrodes disposed on the sides of each electrode, reducing the electrode insertion depth in the z-stacking assembly process, which facilitates electrode stacking, increasing the prismatic cell manufacturing time.

The use of smaller electrodes shortens the current transfer path, reducing cell resistance within the prismatic battery cell.

The use of electrodes having the smaller electrodes disposed on the sides of each electrode, lowers the current density and heat generated within the prismatic battery cell.

This arrangement facilitates more uniform current transfer, and better thermal distribution and voltage change within each of the prismatic battery cells, resulting in reduced battery cell aging.

Such a battery cell may be used in rechargeable energy storage system (RESS) in a vehicle having an electrified propulsion system, for example, but not limited to, a motor vehicle having an electrified powertrain or propulsion system, e.g., an electric vehicle (EV) or plug-in hybrid vehicle (PHEV), or another mobile platform, which may be powered by an electric propulsion system, to reduce cell resistance within the individual prismatic battery cells, thereby improving cell performance.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an electric drivetrain system including a rechargeable energy storage system (RESS) having a plurality of prismatic battery cells, in accordance with the disclosure.

FIG. 2 schematically illustrates cutaway side view of one of the plurality of prismatic battery cells, in accordance with the disclosure.

FIG. 3 schematically illustrates an exploded view of one of the plurality of pairs of electrodes in the first electrode stack, and one of the plurality of pairs of electrodes in the second electrode stack illustrated in FIG. 2, in accordance with the disclosure.

FIG. 4 schematically illustrates an isometric cutaway view of an electrode stack having a plurality of pairs of electrodes in a stacked configuration, in accordance with the disclosure.

FIG. 5 schematically illustrates a z-stacking arrangement of a plurality of pairs of electrodes in an electrode stack illustrated in FIGS. 2 and 4, in accordance with the disclosure.

FIG. 6 schematically illustrates a cutaway side view of one of the plurality of prismatic battery cells including an optional thermal barrier plate, in accordance with the disclosure.

FIG. 7 schematically illustrates a cutaway side view of another of the prismatic battery cells including a jelly-roll configuration, in accordance with another aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

As used herein, the term “electric machine” refers to an electric motor, generator, or motor-generator device including a rotor and a stator that is capable of converting electric power to mechanical power and/or converting mechanical power to electric power by electromagnetic effort.

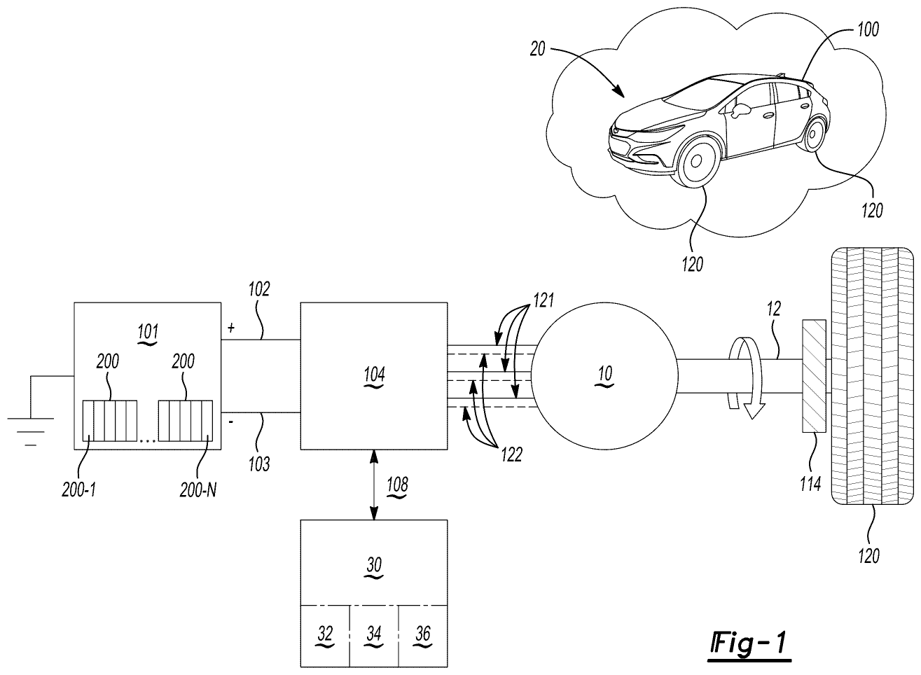

Referring to the drawings, wherein like reference numbers refer to the same or like components in the several Figures, FIG. 1 schematically illustrates an electric drivetrain 100 that is composed of a high-voltage direct current (DC) power source 101, for example but not limited to a rechargeable energy storage system (RESS), a multi-phase power inverter 104, a multi-phase rotary electric motor, generator, or motor-generator (electric machine) 10, and a torque actuator 120, the operations of which are monitored and controlled by a controller 30.

According to one aspect of the disclosure, the electric drivetrain 100 is arranged to generate and transfer torque to actuator 120 in the form of one or multiple drive wheels 120 to effect work. Controller 30 executes control routines 36 to control and manage operation of the multi-phase power inverter 104.

The electric drivetrain 100 is disposed on an electrified vehicle, schematically illustrated at 20, and capable of generating tractive torque for vehicle propulsion. When disposed on the electrified vehicle 20, the electrified vehicle 20 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the electric drivetrain 100 may be an element of a stationary system.

The controller 30 may be embodied as one or more digital computing devices and may include one or more processors 34 and memory 32. A control routine 36 may be stored as an executable instruction set in the memory 32 and executed by one of the processors 34 of the controller 30. The controller 30 is in communication with the multi-phase power inverter 104 to control operation thereof in response to execution of the control routine 36 to operate the electric machine 10.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

The electric machine 10 includes a cylindrically-shaped rotor assembly arranged on a rotor shaft and disposed within an annularly-shaped stator, wherein the rotor assembly is coaxial with a rotor opening that is formed in the stator. Other elements of the electric machine 10, e.g., end caps, shaft bearings, electrical connections, etc., are included but not shown. Electrical windings of the stator are arranged with a quantity of electrical phases and a quantity of electrical turns per phase. Depending on the specific arrangement, the quantity of electrical phases may be between 3 and 6, and the quantity of layers of conductors may be between 4 and 12.

The RESS 101 includes a plurality of prismatic battery cells 200. The multi-phase power inverter 104 is controllable to transform DC electric power to alternating current (AC) electric power, and transform AC electric power to DC electric power, employing a pulse-width modulation signal 108 or another control technique. The multi-phase power inverter 104 is arranged and is controllable to transform DC electric power originating from the RESS 101 to AC electric power to actuate the electric machine 10 via electromagnetic effort. The electric machine 10 is controllable to rotate and generate mechanical torque that is transferred via a rotatable member 12 and a geartrain 114 to the actuator 120 when operating in a torque generating mode. The electric machine 10 is controllable to generate AC electric power from mechanical torque originating at the actuator 120 via electromagnetic effort, which is transformed by the multi-phase power inverter 104 to DC electric power for storage in the RESS 101 when operating in an electric power generating mode.

According to one aspect of the disclosure, the actuator 120 includes a vehicle wheel that transfers torque to a ground surface to effect forward motion as part of a traction propulsion system.

The RESS 101 connects to the multi-phase power inverter 104 via a high-voltage DC bus having a positive link 102 and a negative link 103, and the multi-phase power inverter 104 connects to the electric machine 10 via a plurality of first AC buses 121 and second AC buses 122 to transfer the pulse-width modulation signal 108. While the multi-phase inverter 104 is illustrated as a three-phase inverter, it should be appreciated that the multi-phase inverter 104 is not limited to a three-phase inverter.

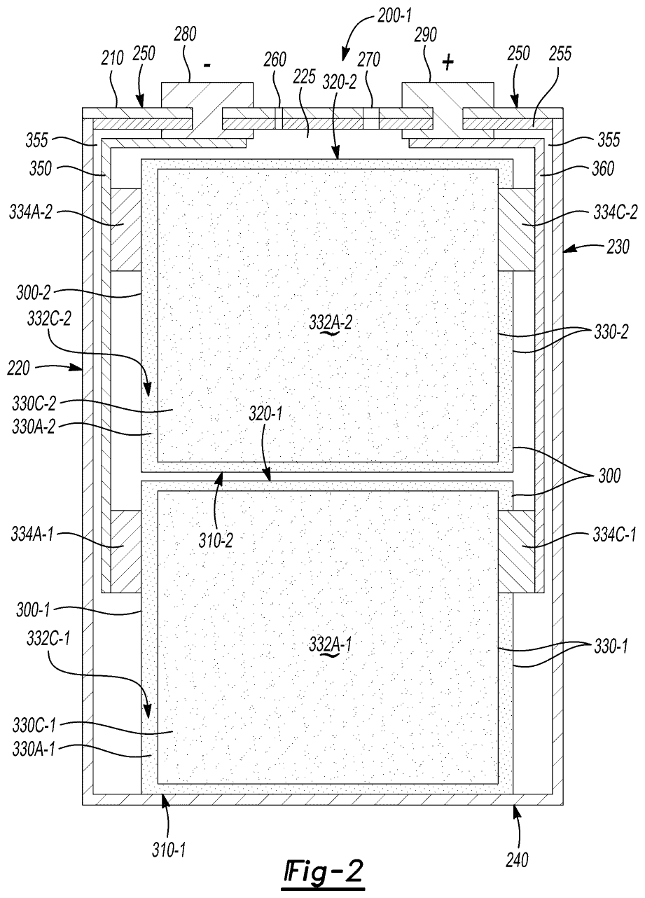

FIG. 2 schematically illustrates cutaway side view of a prismatic battery cell 200-1 of the plurality of prismatic battery cells 200. The prismatic battery cell 200-1 includes a battery can 210 that defines an internal volume 225. The battery can 210 include a first side 230, a second side 230 that is opposite the first side 220, a bottom portion 240, and a top cover portion 250 that is opposite the bottom portion 240.

The top cover portion 250 includes a fill port 260, and a vent 270. An anode terminal 280 and a cathode terminal 290 each extend through the top cover portion 250 of the battery can 210, and into the internal volume 225 defined by the battery can 210. While the anode terminal 280 and the cathode terminal 290 are illustrated as being disposed such that each of the anode terminal 280 and the cathode terminal 290 extend through the top cover portion 250 of the prismatic battery cell 200-1, it should be appreciated that either one or both of the anode terminal 280, and/or the cathode terminal 290 could be disposed to extend through the first side 220, the second side 230, and/or the bottom portion 240 of the battery can 210, or combination thereof.

An insulation plate 255 is disposed within the internal volume 225 defined by the battery can 210. The insulation plate 255 is disposed adjacent to the top cover portion 250 of the battery can 210.

The prismatic battery cell 200-1 further includes at least two electrode stacks 300 including a first electrode stack 300-1 and a second electrode stack 300-2 are disposed within the internal volume 225 defined by the battery can 210, in a vertically stacked arrangement, in which the second electrode stack 300-2 is stacked vertically above the first electrode stack 300-1 within the internal volume 225 defined by the battery can 210. While a first electrode stack 300-1, and a second electrode stack 300-2 are illustrated, it should be appreciated that more than two electrode stacks could be stacked in the vertical arrangement within a battery can of a single prismatic battery cell, as required by the individual application.

In the vertically stacked arrangement, a bottom edge 310-1 of the first electrode stack 300-1 is adjacent to the bottom portion 240 of the battery can 210. A bottom edge 310-2 of the second electrode stack 300-2 is adjacent to a top edge 320-1 of the first electrode stack 300-1, and a top edge 320-2 of the second electrode stack 300-2 is adjacent to the top cover portion 250 of the battery can 210.

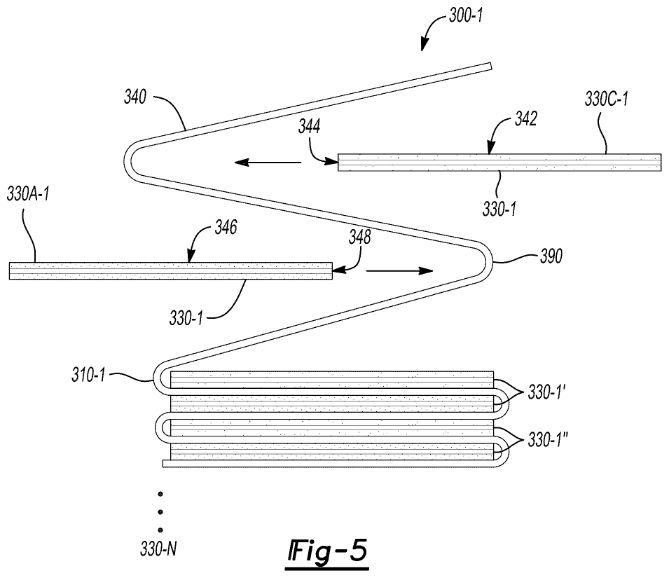

Each of the first electrode stack 300-1, and the second electrode stack 300-2 includes at least two pairs of electrodes 330-1 and 330-2 respectively. Each pair of electrodes 330-1, 330-2 includes an anode 330A-1, 330A-2, and a cathode 330C-1, 330C-2, respectively adjacent to one another. A separator layer 340 (See FIGS. 4 and 5) is disposed between the anode 330A-1 and the cathode 330C-1, and between the anode 330A-2 and the cathode 330C-2.

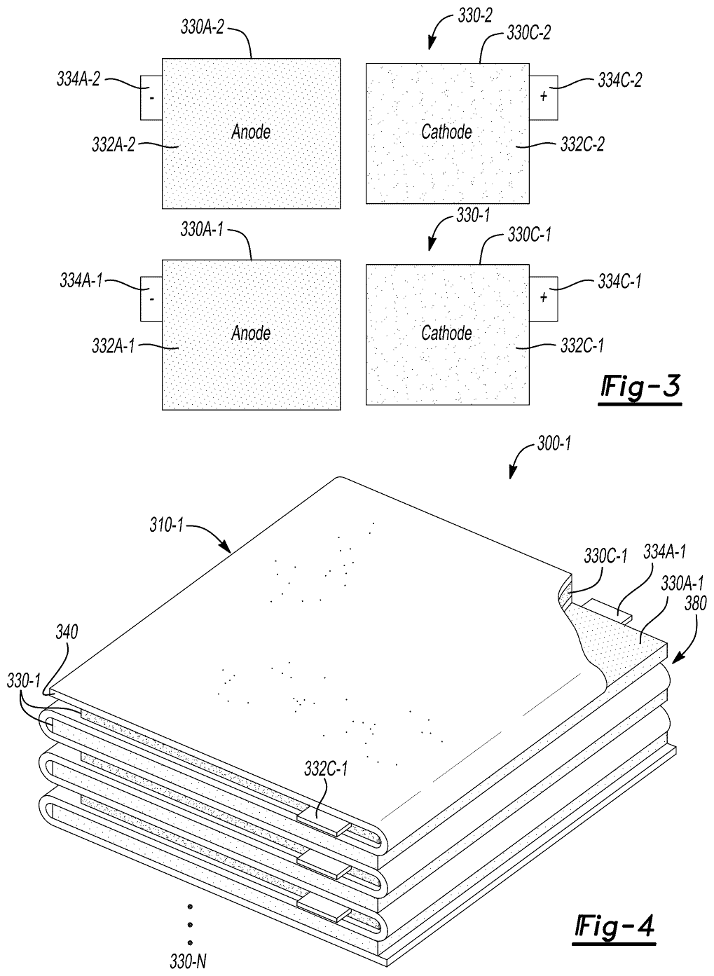

As schematically illustrated in FIG. 3, each of the pairs of electrodes 330-1, 330-2 respectively includes anodes 330A-1, 330A-2, and cathodes 330C-1, 330C-2. Each of the anodes 330A-1, 330A-2 respectively includes anode current collector portions 332A-1, 332A-2, and anode tab portions 334A-1 extending outward from the anode current collector portions 332A-1, 332A-2. Each of the cathodes 330C-1, 330C-2 respectively includes cathode current collector portions 332C-1, 332C-2, and cathode tab portions 334C-1, 334C-2, extending outward from the cathode current collector portions 332C-1, 332C-2.

Referring back to FIG. 2, anodes 330A-1, 330A-2 each respectively include anode current collector portions 332A-1, 332A-2 and anode tab portions 334A-1, 334A-2. Cathodes 330C-1, 330C-2 each respectively include cathode current collector portions 332C-1, 332C-2, and a cathode tab portions 334C-1, 334C-2.

Each of the anode tab portions 334A-1, 334A-2 extend outward from the anode current collector portions 332A-1, 332A-2, respectively, towards the first side 220 of the battery can 210. Each of the cathode tab portions 334C-1, 334C-2 extend outward from the cathode current collector portions 332C-1, 332C-2, respectively towards the second side 230 of the battery can 210.

The prismatic battery cell 200-1 further includes a first internal weld plate 350 and a second internal weld plate 360. The anode tab portions 334A-1 of the first electrode stack 300-1 are connected to one another, for example but not limited to, by welding, and connected to the first internal weld plate 350. The anode tab portions 334A-2 of the second electrode stack 300-2 are connected to one another, for example but not limited to, by welding, and connected to the first internal weld plate 350, which is connected to the anode terminal 280, for example but not limited to, by welding.

The cathode tab portions 334C-1 of the first electrode stack 300-1 are connected to one another, for example but not limited to, by welding, and connected to the second internal weld plate 360. The cathode tab portions 334C-2 of the second electrode stack 300-2 are connected to one another, for example but not limited to, by welding, and connected to the second internal weld plate 360, which is connected to the cathode terminal 290, for example but not limited to, by welding.

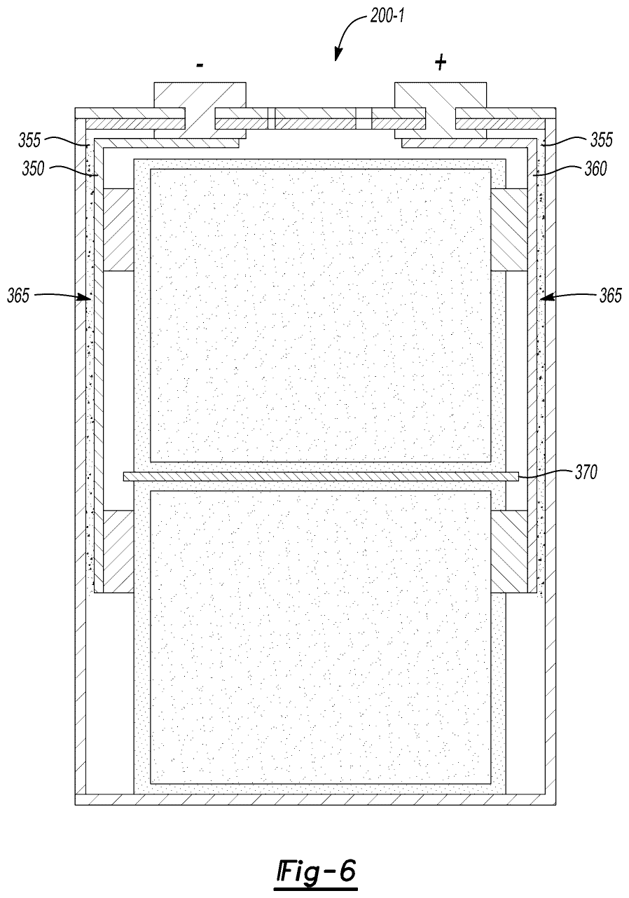

According to one aspect of the disclosure, the first internal weld plate 350, and/or the second internal weld plate 360 are in thermal communication with the battery can 210. As shown in FIG. 6, at least one thermal layer 355 may be disposed within the internal volume 225 defined by the battery can 210, and adjacent to the first side 220 and/or second side 230 of the battery can 210, to facilitate heat transfer. The thermal layer 355 may include, for example but not limited to, a thermal paste 365.

While the first internal weld plate 350 and the second internal weld plate 360 are thermally conductive, they may also be, but are not limited to being thermally and electrically conductive.

According to one aspect of the present disclosure, as illustrated in FIG. 4, each of the first electrode stack 300-1 and the second electrode stack 300-2 includes a first plurality of pairs of electrodes 330-1, 330-2 in a stacked configuration 380.

A separator layer 340 is disposed between each anode 330A-1 and cathode 330C-1 included in each of the first plurality of pairs of electrodes 330-1, and between each of the first plurality of pairs of electrodes 330-1.

It should be appreciated that, while the stacked configuration 380 is illustrated with respect to the first electrode stack 300-1, the stacked configuration 380 also applies to the second electrode stack 300-2, and may apply to subsequent electrode stacks 300-3 through 300-N based on the requirements for each individual application.

FIG. 5 schematically illustrates a z-stack configuration 390 of the separator layer 380 in an electrode stack 300-1 within a prismatic battery cell 200. The separator layer 380 is disposed between the cathode 330C-1, and the anode 330A-1, and between subsequent adjacent pairs of electrodes 330-1, 330-1′, 330-1″, such that the separator layer 340 is disposed along a surface 342 of the cathode 330C-1, wrapping around a bottom edge 344 of the cathode 330C-1, then disposed along a surface 346 of the anode 330A-1, wrapping around a top edge 348 of the anode 330A-1, and repeating for each subsequent cathode, anode in the electrode stack 330-1.

It should be appreciated that, while the z-stack configuration 390 is illustrated with respect to the first electrode stack 300-1, the z-stack configuration 390 also applies to the second electrode stack 330-2, and may apply to subsequent electrode stacks 300-3 through 300-N based on the requirements for each individual application.

Further, while the separator layer 380 in the z-stacking configuration 390 is illustrated as being a single separator layer disposed in between each anode and cathode, and between each pair of electrodes, it should be appreciated that individual separator layers may be disposed between each anode and cathode in a laminate stack, and the laminate stacks may be stacked using the z-stacking arrangement. Each laminate stack may include, for example but not limited to, an anode-cathode-anode (ACA) laminate stack, and/or a cathode-anode-cathode (CAC) laminate stack, such that each of the plurality of the laminate stacks is disposed in an electrode stack using the z-stack configuration 390.

FIG. 6 schematically illustrates a cutaway side view of the prismatic battery cell 200-1, of the plurality of prismatic battery cells 200, including a thermal barrier plate 370 disposed between the first electrode stack 330-1 and the second electrode stack 330-2. In case of thermal runaway in one of the plurality prismatic battery cells 200, the thermal barrier plate 370 would delay onset of thermal runaway between the electrode stacks within the prismatic battery cell. The thermal barrier plate 370 includes a high temperature material, for example but not limited to, metal, plastic or nylon with a high glass fill content, mica, or the like suitable to operate in an electrochemical environment.

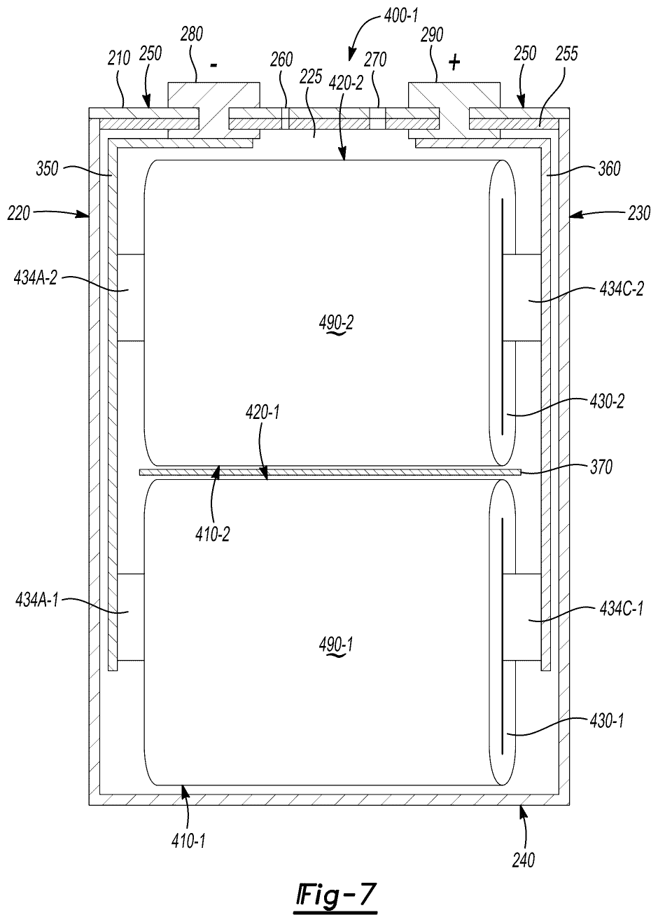

According to another aspect of the disclosure, as schematically illustrated in FIG. 7, a prismatic battery cell 400-1 includes a jelly roll configuration in which a first jelly roll 490-1 is disposed within the internal volume 225 defined by the battery can 210. A second jelly roll 490-2 is stacked vertically adjacent to the first jelly roll 490-1 within the internal volume 225 defined by the battery can 210.

A bottom edge 410-1 of the first jelly roll 490-1 is disposed adjacent the bottom portion 240 of the battery can 210. A bottom edge 410-2 of the second jelly roll 490-2 is disposed adjacent to a top edge 420-1 of the first jelly roll 490-1, while a top edge 420-2 of the second jelly roll 490-2 is disposed adjacent to the top cover portion 250 of the battery can 210.

The first jelly roll 490-1 includes a first electrode stack 430-1 rolled to form the first jelly roll 490-1. An anode tab portion 434A-1 extends outward from the first jelly roll 490-1 towards the first side 220 of the battery can 210. A cathode portion 434C-1 extends outward from the second jelly roll 490-2 towards the second side of the battery can 210.

The second jelly roll 490-2 includes a second electrode stack 430-2 rolled to form the second jelly roll 490-2. An anode tab portion 434A-2 extends outward from the second jelly roll 490-2 towards the first side 220 of the battery can 210. A cathode portion 434C-2 extends outward from the second jelly roll 490-2 towards the second side of the battery can 210.

The anode tab portions 434A-1, 434A-2 are connected to a first internal weld plate 350, and the cathode portions 434C-1, 434C-2 are connected to the second internal weld plate 360.

Thermal barrier plate 370 may also be disposed between the first jelly roll 490-1 and the second jelly roll 490-2. In case of thermal runaway in one of the plurality prismatic battery cells 200, the thermal barrier plate 370 would delay onset of thermal runaway in the remaining plurality of prismatic battery cells 200. The thermal barrier plate 370 includes a high temperature material, for example but not limited to, metal, nylon with a high glass fill content, mica, or the like.

A prismatic battery cell including multiple multilayer electrode stacks stacked within the battery can in a vertically stacked configuration allows for smaller electrodes disposed on the sides of each electrode, reducing the electrode insertion depth in the z-stacking assembly process, which facilitates electrode stacking, increasing the prismatic cell manufacturing time.

The use of smaller electrodes shortens the current transfer path, reducing cell resistance within the prismatic battery cell.

The use of electrodes having the smaller electrodes disposed on the sides of each electrode, lowers the current density and heat generated within the prismatic battery cell.

This arrangement facilitates more uniform current transfer, and better thermal distribution and voltage change within each of the prismatic battery cells, resulting in reduced battery cell aging.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. A prismatic battery cell comprising:
a battery can defining an internal volume, the battery can including:
a first side;
a second side opposite the first side;
a bottom portion; and
a top cover portion opposite the bottom portion; and
at least two electrode stacks including:
a first electrode stack; and
a second electrode stack, wherein the first electrode stack and the second electrode stack are disposed within the internal volume defined by the battery can in a vertically stacked arrangement.

2. The prismatic battery cell as recited in claim 1, wherein a bottom edge of the first electrode stack is adjacent to the bottom portion of the battery can; and
wherein a bottom edge of the second electrode stack is adjacent to a top edge of the first electrode stack, and a top edge of the second electrode stack is adjacent to the top cover portion of the battery can.

3. The prismatic battery cell as recited in claim 2, wherein each of the first electrode stack and the second electrode stack includes at least two pairs of electrodes, wherein each pair of electrodes includes:
an anode; and
a cathode adjacent to the anode in a stacked configuration; and
a separator layer disposed between the anode and the cathode.

4. The prismatic battery cell as recited in claim 3, wherein each respective anode of the at least two pairs of electrodes includes an anode current collector portion and an anode tab portion extending outward from the anode current collector portion toward the first side of the battery can, and
wherein each respective cathode of the at least two pairs of electrodes includes a cathode current collector portion and a cathode tab portion extending outward from the cathode current collector portion toward the second side of the battery can.

5. The prismatic battery cell as recited in claim 4, further including:
an anode terminal;
a cathode terminal, wherein the anode terminal extends through at least one of the first side, the second side, the bottom portion, and the top cover portion of the battery can, and wherein the cathode terminal extends through at least one of the first side, the second side, the bottom portion and top cover portion of the battery can;
a first internal weld plate; and
a second internal weld plate, wherein the first internal weld plate is connected to the anode tab portions of the first electrode stack, the anode tab portions of the second electrode stack, and the anode terminal; and
wherein the second internal weld plate is connected to the cathode tab portion of the first electrode stack, the cathode tab portion of the second electrode stack, and the cathode terminal.

6. The prismatic battery cell as recited in claim 5, wherein each the first internal weld plate and the second internal weld plate are in thermal communication with the battery can.

7. The prismatic battery cell as recited in claim 5, wherein the first electrode stack includes a first plurality of pairs of electrodes, and
wherein the second electrode stack includes a second plurality of pairs of electrodes, and
wherein each of the first plurality of pairs of electrodes and the second plurality of pairs of electrodes are disposed in a stacked configuration.

8. The prismatic battery cell as recited in claim 7, wherein the separator layer of the first electrode stack is disposed between each anode and cathode included in each of the first plurality of pairs of electrodes, and between each of the first plurality of pairs of electrodes.

9. The prismatic battery cell as recited in claim 8, wherein the separator layer of the second electrode stack is disposed between each anode and cathode included in each of the second plurality of pairs of electrodes, and between each of the second plurality of pairs of electrodes.

10. The prismatic battery cell as recited in claim 9, wherein the separator layer of the first electrode stack includes a z-stack configuration, and wherein the separator layer of the second electrode stack includes a z-stack configuration.

11. The prismatic battery cell as recited in claim 1, further including an insulation plate disposed within the internal volume defined by the battery can, and adjacent to the top cover portion of the battery can.

12. The prismatic battery cell as recited in claim 1, further including a thermal barrier plate disposed between the first electrode stack and the second electrode stack.

13. The prismatic battery cell as recited in claim 1, wherein each of the first electrode stack and the second electrode stack include a jelly-roll configuration.

14. The prismatic battery cell as recited in claim 1, further including at least one thermally conductive layer disposed within the internal volume defined by the battery can, and adjacent to the first side and/or the second side of the battery can.

15. A rechargeable energy system (RESS) for an electrified vehicle, the RESS comprising:
a plurality of prismatic battery cells, wherein each of the prismatic battery cells includes:
a battery can defining an internal volume, the battery can including:
a first side;
a second side opposite the first side;
a bottom portion; and
a top cover portion opposite the bottom portion; and
at least two electrode stacks including:
a first electrode stack; and
a second electrode stack, wherein the first electrode stack and the second electrode stack are disposed within the internal volume defined by the battery can in a stacked arrangement;
an anode terminal; and
a cathode terminal, wherein the anode terminal extends through at least one of the first side, the second side, the bottom portion, and the top cover portion of the battery can, and wherein the cathode terminal extends through at least one of the first side, the second side, the bottom portion and top cover portion of the battery can.

16. The RESS as recited in claim 15, wherein a bottom edge of the first electrode stack is adjacent to the bottom portion of the battery can; and
wherein a bottom edge of the second electrode stack is adjacent to a top edge of the first electrode stack, and a top edge of the second electrode stack is adjacent to a top portion of the battery can.

17. The RESS as recited in claim 16, wherein each of the first electrode stack and the second electrode stack includes at least one pair of electrodes, wherein each pair of electrodes includes:
an anode; and
a cathode adjacent to the anode in a stacked configuration; and
a separator layer disposed between the anode and the cathode.

18. The RESS as recited in claim 17, wherein each anode includes an anode current collector portion and an anode tab portion extending outward from the anode current collector portion toward the first side of the battery can, and
wherein each cathode includes a cathode collector portion and a cathode tab portion extending outward from the cathode current collector portion toward the second side of the battery can.

19. The RESS as recited in claim 15, further including a thermal barrier plate disposed between the first electrode stack and the second electrode stack, wherein each of the first electrode stack and the second electrode stack include a jelly-roll configuration.

20. An electrified vehicle comprising:
a vehicle body;
an electric drivetrain disposed on the electrified vehicle and coupled to the vehicle body; and
a rechargeable energy storage system (RESS) in communication with the electric drivetrain, wherein the RESS includes:
a plurality of prismatic battery cells, wherein each of the prismatic battery cells includes:
a battery can defining an internal volume, the battery can including:
a first side;
a second side opposite the first side;
a bottom portion; and
a top cover portion opposite the bottom portion; and
at least two electrode stacks including:
a first electrode stack; and
a second electrode stack, wherein the first electrode stack and the second electrode stack are disposed within the internal volume defined by the battery can in a stacked arrangement, wherein a bottom edge of the first electrode stack is adjacent to the bottom portion of the battery can; and
wherein a bottom edge of the second electrode stack is adjacent to a top edge of the first electrode stack, and a top edge of the second electrode stack is adjacent to a top portion of the battery can.
